(19) United States
(12) Patent Application Publication
(10) Pub. No.: US 2014/0229287 A1
(43) Pub. Date: Aug. 14, 2014

(54) SYSTEM AND METHOD FOR PROVIDING INTERACTIVE TOUR GUIDANCE

(71) Applicants: Yoav BEN-DAVID, Tel Aviv (IL); Boaz BEERI, Bakaa (IL); TOUR PAL LTD, Jerusalem (IL)

(72) Inventors: Yoav BEN-DAVID, Tel Aviv (IL); Boaz BEERI, Bakaa (IL)

(73) Assignees: TOUR PAL LTD, Jerusalem (IL); Yoav BEN-DAVID, Tel Aviv (IL); Boaz BEERI, Bakaa (IL)

(21) Appl. No.: 14/253,975

(22) Filed: Apr. 16, 2014

Related U.S. Application Data
(63) Continuation-in-part of application No. PCT/IL2012/000358, filed on Oct. 11, 2012.
(60) Provisional application No. 61/548,227, filed on Oct. 18, 2011.

(51) Int. Cl. G06Q 30/02

(52) U.S. Cl. CPC G06Q 30/0269; G06Q 30/0261
USPC 705/14.58; 705/14.66

(57) ABSTRACT

A system adapted to provide tourist and marketing information. The system includes: a database of tourist information, the database is accessible to internet users; a server for collecting and storing the database of tourist information; and a plurality of electronic devices in communication with the database. Each electronic device includes: structure for presenting the tourist information; and a computer readable medium (CRM) encoded with instructions thereon for presenting the tourist information from the database. The database is updated by the internet users. The instructions are for: creating a social network between users of the plurality of the electronic device; and updating and commenting on the tourist information via the social network.

### FIELD OF THE INVENTION

The present invention relates generally to the field of tour-guiding, and more specifically, for tour guiding, with user generated audio tour guides, a user based tour rating system and location based advertising, by an electronic device which also offers location based information.

### BACKGROUND

Personally guided tours require a pre-set schedule of the tour, organizing groups of tourists and high cost. Current cellular application provides just textual information, typically unsorted with no supervision on the content.

TRIPOSO application, provides tourist information, it can be provided both online and offline. In addition, upon request, an audio of the information can be played. However, this application does not operate the audio automatically upon detection of user location using a GPS. It also, does not provide open access to its data base.

JP2006072142 is a patent application which claims a device for playing audio during an exhibition. The device comprises a wearable sensor for locating location of user, when the sensor locates user's location at a specific place at the exhibition, it plays the related audio.

However, this system, requires special equipment and cannot be produced as a software with no other requirements. It also does not provide any access to their data base.

There is therefore a long unmet need, for a tour-guiding application which will also be used as a social network, for sharing and improving content of the tour guides.

### SUMMARY OF THE INVENTION

It is one object of the current invention, to disclose a system adapted to provide tourist and marketing information, comprising:
a. a database of tourist information; said data base is accessible to internet users;
b. a server for collecting and storing said database of tourist information;
c. a plurality of electronic devices in communication with said database; each said electronic device comprising (i) means for presenting said tourist information and (ii) a computer readable medium (CRM) having instructions thereon for presenting said tourist information from said database;
   wherein said database is updated by the internet users; further wherein said instructions are for (i) creating a social network between users of the plurality of electronic device according to predefined point of interest (POI); and (ii) updating and commenting on the tourist information via the social network; further wherein the server comprising means for reducing file size of the database of tourist information; the server focuses upon the POI such that the database of the POI is collected, compressed and transferred to the user

It is another object of the current invention to disclose the system as defined above, wherein the means for reducing file size is selected from the group consisting of a zip file platform, RAR, bzip2, Izma, gzip, PNG, GIF, TIFF, MNG.

It is another object of the current invention to disclose the system as defined above, wherein the server further comprising a tour-guides management unit, a user's-management unit, an advertisers-management unit, a user identification platform and a database (DB) unit.

It is another object of the current invention to disclose the system as defined above, wherein the means for presenting the tourist information is selected from a group consisting of screen, speaker, touch stimulator, any module adapted to stimulate a sense, and a combination thereof; further wherein the means for presenting the tourist information comprises an audio information regarding the POI.

It is another object of the current invention to disclose the system as defined above, wherein at least one of the plurality of the electronic devices comprises a global positioning system (GPS).

It is another object of the current invention to disclose the system as defined above, wherein the tourist information regarding the POI is presented upon detection of the electronic device in proximity of a specific location by the GPS.

It is another object of the current invention to disclose the system as defined above, wherein the marketing information regarding a location is sent to the electronic device; the information is sent upon detection by the GPS of the electronic device in proximity to the location.

It is another object of the current invention to disclose the system as defined above, wherein at least one of the following is true:
a. the information is presented automatically;
b. the information is presented upon request from the electronic device user;
c. the tourist information is a guided tour through several locations; and
d. the tourist information is presented in more than one language.

It is another object of the current invention to disclose the system as defined above, wherein the update of data base is approved by at least one administrator.

It is another object of the current invention to disclose the system as defined above, wherein marketing information is sent to the electronic device by an advertiser which is in communication with the database.

It is another object of the current invention to disclose the system as defined above, wherein the server is configured to perform at least one of the following actions in the database: upload data, update existing data, receive business intelligent, and any combination thereof.

It is another object of the current invention to disclose the system as defined above, wherein the server is further configured as a platform for the users of the social network to provide tour-guides; the tour-guides are used via a transit selected from a group consisting of: bicycle, motorcycle, airplane, car, walk, train, bus, rickshaw, skates, roller-blades, and a combination thereof.

It is another object of the current invention to disclose the system as defined above, wherein the instructions are additionally for optimizing tour-guides according to parameters selected from a group consisting of: rating, length of route, unique of sited along routes, time of day in which the tour-guides are taken, time of year in which the tour-guides are taken, events along the tour and a combination thereof.

It is another object of the current invention to disclose the system as defined above, wherein the CRM is in communication with augmented reality application.

It is another object of the current invention to disclose a method for providing tourist and marketing information, comprising steps of:
a. providing a system adapted to provide tourist and marketing information, comprising:
   i. a database of tourist information; the data base is accessible to internet users;
   ii. a server for collecting and storing the database of tourist information, the server comprising means for reducing file size of the database of tourist information; and
   iii. a plurality of electronic devices in communication with the database; each the electronic device comprising (i) means for presenting the tourist information according to predefined point of interest (POI) and, (ii) a computer readable medium (CRM) having instructions thereon for presenting the tourist information from the database;
b. communicating between (i) the plurality of electronic devices; and (ii) the database in communication with the database;
wherein the method additionally comprising steps of:
c. creating a social network between users of the plurality of electronic device;
d. updating and commenting on the tourist information via the social network;
e. focusing upon the POI; and
f. collecting, compressing and transferring the database of the POI to the user.

It is another object of the current invention to disclose the method as defined above, wherein the means for presenting the tourist information is selected from a group consisting of screen, speaker, touch stimulator, any module adapted to stimulate a sense, and a combination thereof.

It is another object of the current invention to disclose the method as defined above, wherein at least one of the following steps is true:
a. providing at least one of the plurality of electronic devices a global positioning system (GPS); and
b. presenting the tourist information regarding a specific location, upon detection of the electronic device in proximity of the specific location by the GPS.

It is another object of the current invention to disclose the method as defined above, additionally comprising step of sending the marketing information regarding a location to the electronic device; the information is sent upon detection by the GPS of the electronic device in proximity to the location.

It is another object of the current invention to disclose the method as defined above, wherein at least one of the following steps is true:
a. presenting the information automatically;
b. presenting the information upon request from the electronic device use;
c. presenting the information as tour-guides through several locations; and
d. presenting the tourist information in more than one language.

It is another object of the current invention to disclose the method as defined above, wherein the method additionally comprising step of approving the update of data base by at least one administrator.

It is another object of the current invention to disclose the method as defined above, wherein the method additionally comprising step of sending marketing information to an electronic device by an advertiser.

It is another object of the current invention to disclose the method as defined above, wherein the method additionally comprising step of communicating between advertiser and the database; the server is configured to perform at least one of the following actions in the database: uploading data, updating existing data, receiving business intelligent, and any combination thereof.

It is another object of the current invention to disclose the method as defined above, wherein the method additionally comprising step of providing the means for presenting information with audio information regarding the POI.

It is another object of the current invention to disclose the method as defined above, wherein at least one of the following steps is true:
a. using tour-guides with a transit selected from a group consisting of: bicycle, motorcycle, airplane, car, walk, train, bus, rickshaw, skates, roller-blades, and a combination thereof; and
b. optimizing the tour-guides according to parameters selected from a group consisting of: rating, length of route, unique of sited along routes, time of day in which the tour-guides are taken, time of year in which the tour-guides are taken, events along the tour and a combination thereof.

It is another object of the current invention to disclose the method as defined above, additionally comprising step of communicating the CRM with an augmented reality application.

### BRIEF DESCRIPTION OF THE DRAWINGS

In order to understand the invention and to see how it may be implemented in practice, a few preferred embodiments will now be described, by way of non-limiting example only, with reference to be accompanying drawings, in which:

FIG. 1 presents an illustration of an interactive-tour-guidance system, according to variations of the present invention

FIG. 2 illustrates a flow chart showing an example method of a tour creation by an approved tour-guide person, uploading and/or managing tour guides of one or more tour sites, according to embodiments of the present invention;

FIG. 3 shows a schematic flow chart showing an example method of creating an advertising item for coupled with a point of interest, according to embodiments of the present invention;

FIG. 4 is a schematic flow chart showing an example method of selecting one or more tours by a user, according to embodiments of the present invention; and

FIG. 5 is a schematic flow chart showing an example method of providing an advertisement, in real time, to a user of a particular tour, according to embodiments of the present invention;

FIG. 6 illustrates a flow chart of a method for providing tourist and marketing information; and

FIG. 7 illustrates a flow chart of a method for providing tourist and marketing information according to a user's POI.

### DETAILED DESCRIPTION OF THE INVENTION

The following description is provided so as to enable any person skilled in the art to make use of the invention and sets forth examples contemplated by the inventor of carrying out this invention. Various modifications, however, will remain apparent to those skilled in the art, since the generic principles of the present invention have been defined specifically. Also, it is to be understood that the phraseology and terminology employed herein is for the purpose of description and should not be regarded as limiting.

The present invention provides a system for providing and constructing a tourist and marketing information. The system comprising: (a) a database of tourist information accessible to internet users, (b) a server for collecting and storing the database of tourist information, the server further comprising means for reducing file size of the database of tourist information and,

(c) a plurality of electronic devices in communication with the database, each electronic device comprising (i) means for presenting the tourist information and (ii) a computer readable medium (CRM) having instructions thereon for presenting the tourist information from the database.

The database is updated by the internet users. Furthermore, the CRM's instructions are for (i) creating a social network between users of the plurality of electronic device, and (ii) updating and commenting on the tourist information via the social network. The server further focuses upon the POI such that the database of the POI is collected, compressed and transferred to the user

In another embodiment of the present invention, the system may further comprise a user identification (UID) and authentication as a secure identification platform and further providing access to the registered user. The UID recognizes the user entering or assigned the system through the use of logon passwords which is based upon pre-inserted identification information of the user (such as user address, name, ID number or other details).

The UID may further identify other kinds of entities such as groups, departments, mailing lists, roles, computer-based services and the like.

In another embodiment of the present invention, the system is based upon at least one of the following processes verification, certification, authentication and validation. Each of these processes may be a sub process of the other or a independent process of the present invention system. The level of verification, or number of times the producer's data is verified against is not limited and relies upon the user's actions and inputs.

The Authentication platform may be configured to present both a public identifier such as a user name or identification number and private authentication information, such as a Personal Identification Number (PIN), password, or information derived from a cryptographic key.

The present invention further provides a method for providing tourist and marketing information, comprising steps of:

(a) providing a system adapted to provide tourist and marketing information, comprising: a database of tourist information; the data base is accessible to internet users, a server for collecting and storing the database of tourist information, the server comprising means for reducing file size of the database of tourist information and, a plurality of electronic devices in communication with the database, each the electronic device comprising (i) means for presenting the tourist information according to predefined point of interest (POI) and, (ii) a computer readable medium (CRM) having instructions thereon for presenting the tourist information from the database;

The method of the present invention further comprising steps of:

(b) communicating between (i) the plurality of electronic devices; and (ii) the database in communication with the database,

(c) creating a social network between users of the plurality of electronic device;

(d) updating and commenting on the tourist information via the social network;

(e) focusing upon the POI; and

(f) collecting, compressing and transferring the database of the POI to the user.

The term “electronic device”, refers hereinafter to any device selected from a group consisting of mobile device, smart phone, tablet, personal computer, laptop, user interface platform, graphical user interface (GUI) and any other electronic device comprising a computer readable medium.

The term “social network”, refers hereinafter to any online service, platform, or site that focuses on facilitating the building of social networks or social relations among people who, for example, share interests, activities, backgrounds, or real-life connections.

The term “advertiser”, refers hereinafter to any entity with an interest of publishing a product. It may refer to a store, a theater, hotel, a transporter, a parking provider, a restaurant, coffee shops, taxi service, rescue service, an owner of a tourist site etc.

The term “augmented reality”, refers hereinafter to any application or user interface platform which provides a live, direct or indirect, view of a physical, real-world environment whose elements are augmented by computer-generated sensory input such as sound, video, graphics or Global Positioning System (GPS) data.

The term “point of interest (POI)”, refers hereinafter to a desired location of a user, place, region, area, coordinate, zone or association of location according to a specific classification or characteristic.

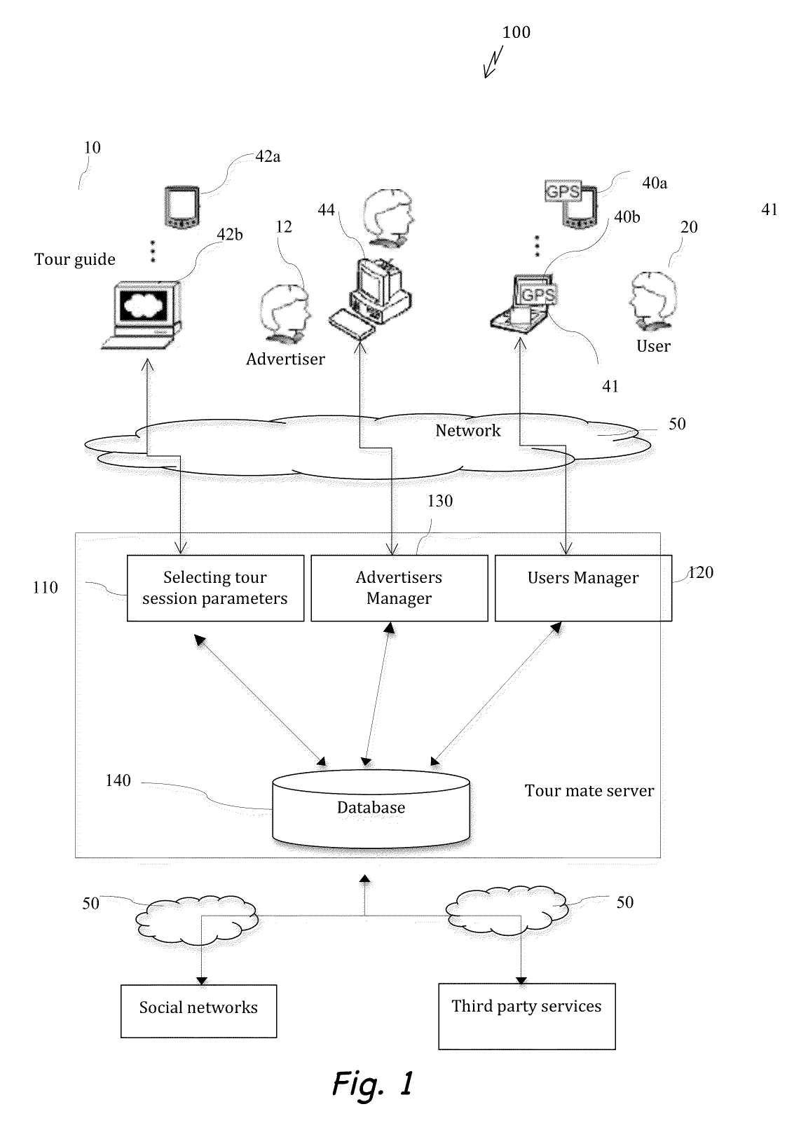

Reference is now made to FIG. 1, illustrating in a non-limiting manner an interactive-tour-guidance system 100. Interactive-tour-guidance system 100 includes a server, the server comprises a tour-guides management unit 110, a user's-management unit 120, an advertisers-management unit 130 and a database (DB) unit 140. The server is further configured as a platform for the users of the social network to provide tour-guides of their own.

The user 20 having a portable communication device such as a smart phone 40a and a laptop 40b, should be operationally connected to the system server, typically, via user's-management unit 120, over a network 50. The network may be an internet network, a cellular network or any other known network. Portable communication device such as a smart phone 40a comprising an user interface platform, operable by a processor of the portable communication device, facilitating the communication with the system server. Preferably, selected portable device 40 includes a GPS device 41.

A tour-guide 10, having a communication device 42, may operationally connect to the system server, typically, via tour-guides management units 110, over a network 50, such as an internet network, a cellular network or any other network. Tour-guide 10 may upload/update recorded guides to one or more points of interest. Optionally, the user POI may further be selected according to comments of others in the social networks. The service provider operating server may approve an uploaded tour. Typically tour guide 10 puts a price tag of using his recorded tour, which price may also need approval of the service provider operating server. Upon a user purchasing the tour of tour guide 10, tour guide 10 receives a payment according to the requested price tag.

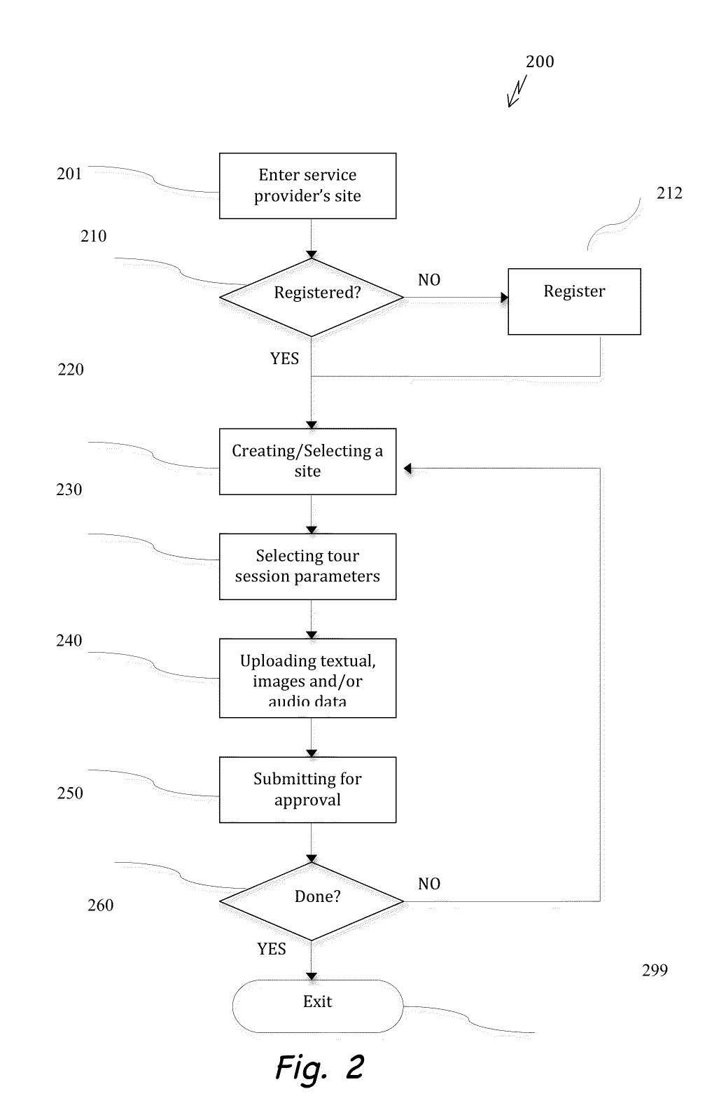

Reference is now made to FIG. 2, which describes in a non-limiting manner, a method 200 of a tour creation by an approved tour-guide person 10, uploading and/or managing tour guides of one or more tour-sites. Step 201 reveals registration a tour guide 10 in order to upload one or more tour guides into DB 140 of system 100, or in order to update, manage or edit one or more guided tours in DB 140. Typically, if tour-guide person 10 is not a registered user of the services provided by system 100 (step 210), tour-guide person 10 may register to the service in step 212 and obtain a user-name and optionally a password.

Once tour-guide person 10 is registered and logged into system 100, process 200 proceeds as follows:

Step 220: creating/selecting a site.

Tour guide-guide person 10 uploads new data relating a particular point of interest (POI) into DB 140 and/or updates, and/or manages, and/or edits one or more existing data record in DB 140, typically, via tour-guides management unit 110. When creating a new tour, tour-guide person 10 gives the tour a unique data entry name. Tour-guide person 10 selects a particular POI that may be one of a multiplicity of POI's composing a city-tour or site-tour, having a multiplicity of POI's.

Step 230: selecting tour session parameters. Tour guide-guide person 10 provides, for each POI, parameters describing

the guided tour session, for example, language, duration, difficulty, etc.

Step 240: uploading textual, images and/or audio data. Tour guide-guide person 10 provides, for each POI, textual, images and/or audio data. Preferably, the POI description includes an audio description, similar to the descriptions given in live-person guided tours.

Step 250: submitting for approval. Tour guide-guide person 10 submits the newly created POI data entry for approval, typically, by the services provided by system 100.

Step 260: check of all POIs are entered/updated. If tour-guide person 10 has completed to enter/update all POIs, go to exit (299).

If tour-guide person 10 wishes to enter/update another POI, go to step 220.

It should be noted that a guide tour may suit a car-tour, a tour-by-foot or both, and may be labeled as such.

It should be further noted that after the new/updated tour is approved, tour-guide person 10 can share his/her tours via social networks, and can edit the tour, manage and see analytics, receive feedback, download history and payments records, etc.

Optionally, a particular tour-guide person 10, that his/her recorded guided-tour is activated, on-site, by a user 20, shares the revenue obtained by the service provider operating server from user 20.

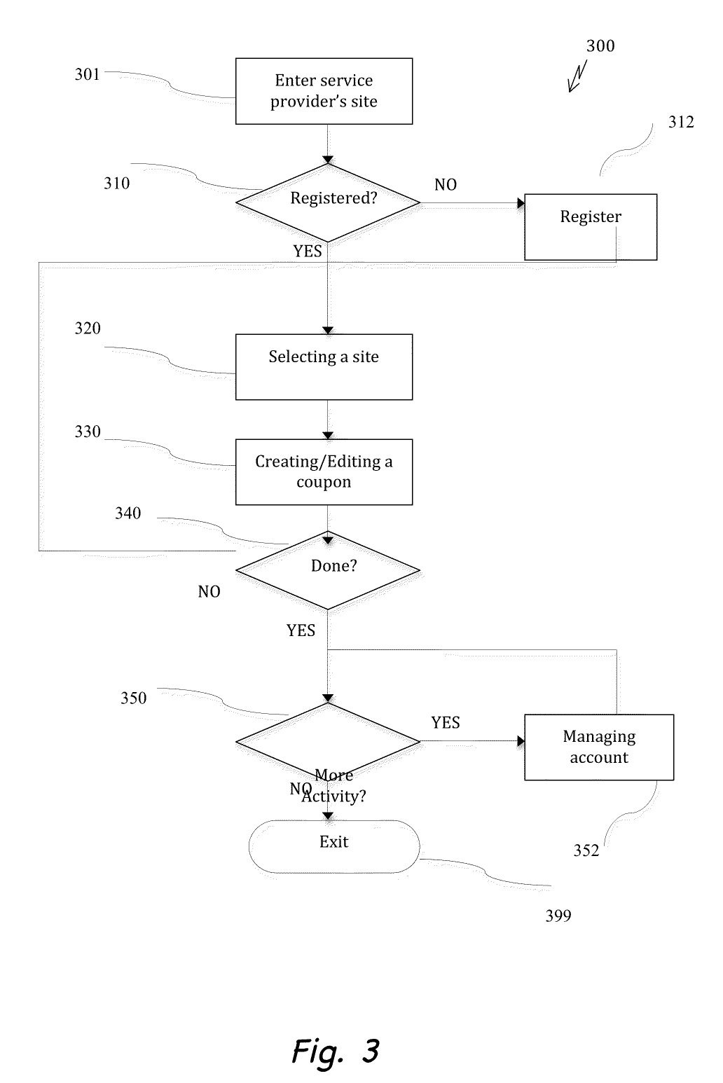

An advertiser 12, having a communication device 44, may operationally connect to tour-mate server, typically, via advertisers-management unit 130, over a network 50, such as an internet network, a cellular network or any other network. Advertiser 12 may upload/update one or more coupons and/or any other discounts in the vicinity of one or more selected points of interest. An advertiser 12 is typically invoiced for each referral to his/her business via the system server. For example, via a pay-per-click scheme, payper downloaded coupon, pay per redeemed coupon, etc. Reference is now made to FIG. 3, an example method 300 of a creating an advertising campaign, in one or more guided-tours, by an approved advertiser 12, uploading and/or managing coupons and/or any other discounts (“coupons”) in the vicinity of one or more selected POIs, according to embodiments of the present invention. Advertiser 12 enters system 100 in step 301, in order to upload one or more coupons into DB 140 of system 100, or in order to update, manage or edit one or more coupons in DB 140. Typically, if advertiser 12 is not a registered user of the services provided by system 100 (check step 310), advertiser 12 may register to the service in step 312 and obtain user name and optionally a password.

An advertiser may be a store, a theater, a transporter, a parking provider, a restaurant, coffee shops, etc.

Once advertiser 12 is registered and logged into system 100, process 300 proceeds as follows: Step 320: selecting a site. Advertiser 12 selects a guided tour or POI from DB 140, being in the vicinity of the business site of advertiser 12, typically, via advertisers-management unit 130. Step 330: creating/editing a coupon. Advertiser 12 uploads/updates one or more coupons and/or any other discounts in the vicinity of one or more selected points of interest. A coupon may include an ID, a QR code, a name, product description, price, discount rate, area, time of issue, time of expiration, etc.

Step 340: check of all coupons are entered/updated.

If advertiser 12 wishes to enter/update another coupon, go to step 320. Step 350: check more activities. If advertiser 12 has completed activity, go to exit (399).

Step 352: manage account. Advertiser 12 may mange account. For example, see how many coupons ware clicked, view the account balance and invoices, etc. Go to step 350.

It should be noted that advertiser 12 is typically invoiced for each referral to his/her business via the system server. For example, via a pay-per-click scheme, pay per downloaded coupon, pay per redeemed coupon, etc.

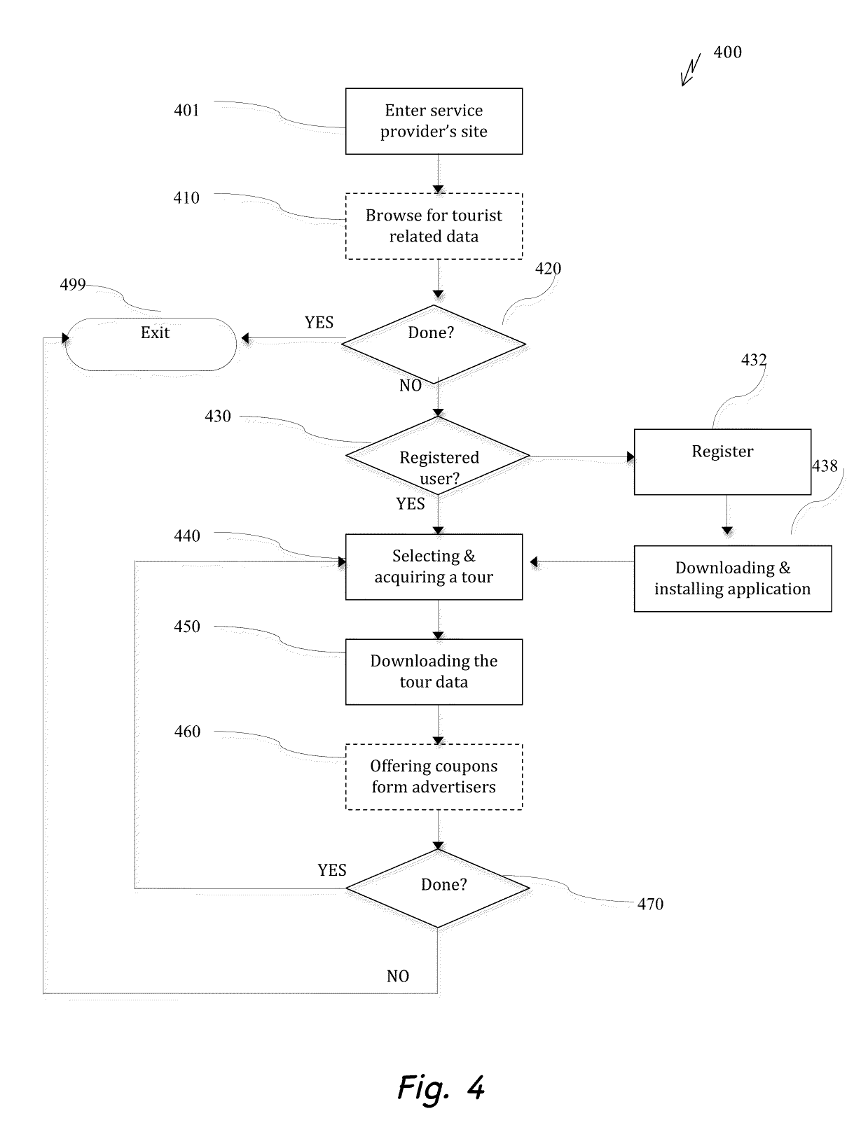

Reference is now made to FIG. 4, an example method 400 of selecting one or more tours by a user 20, according to embodiments of the present invention. User 20 enters system 100 in step 401, in order to optionally browse for tourist related data (step 410). If done browsing (check step 450), user 20 exits system 100 (step 499). Otherwise, if user 20 wants to purchase a guided tour from system 100 then typically, if user 20 is not a registered user of the services provided by system 100 (check step 430), user 20 may register to the service in step 432 and obtain a user name and optionally a password. A user may also be registered at an application distribution store or to another equivalent service. User 20 then downloads a user interface platform 150 from system 100 instep 438, and installs user interface platform 150 in his/her selected portable device 40, to facilitated real time communication between the selected portable device 40 and interactive-tour-guidance system 100. Preferably, selected portable device 40 includes a GPS device 41.

Once user 20 is registered and logged into system 100, process 400 proceeds as follows: Step 440: selecting and acquiring a tour. User 20 selects and purchases one or more guided tours from DB 140, typically, via users-management unit 120. It should be noted that the purchasing of guided tours may be done online or at store outlets. If purchase is not approved, go to exit (499). Step 450: downloading the tour data. User 20 the purchases guided tour into his/her selected portable device 40. Preferably, the data is stored locally in order to avoid data roaming costs. Step 460: offering coupons form advertisers. Optionally, interactive-tour-guidance system 100 offers user 20 with one or more coupons and/or any other discounts, provided by registered advertisers 12 located in the vicinity of one or more points of interest in the purchased guided tour. A guided tour data files may include GPS coordination, audio files, images, relevant promotions, etc. Optionally, assuming a network 50 is available, during and/or after a guided tour, user 20 wishes will be offered to share his/her tour experience, using interactive-tour-guidance system 100, with friends of his/her choice.

Step 470: check if completed activities.

If user 20 wishes to purchase another guided tour, go to step 440. Else, go to exit (499).

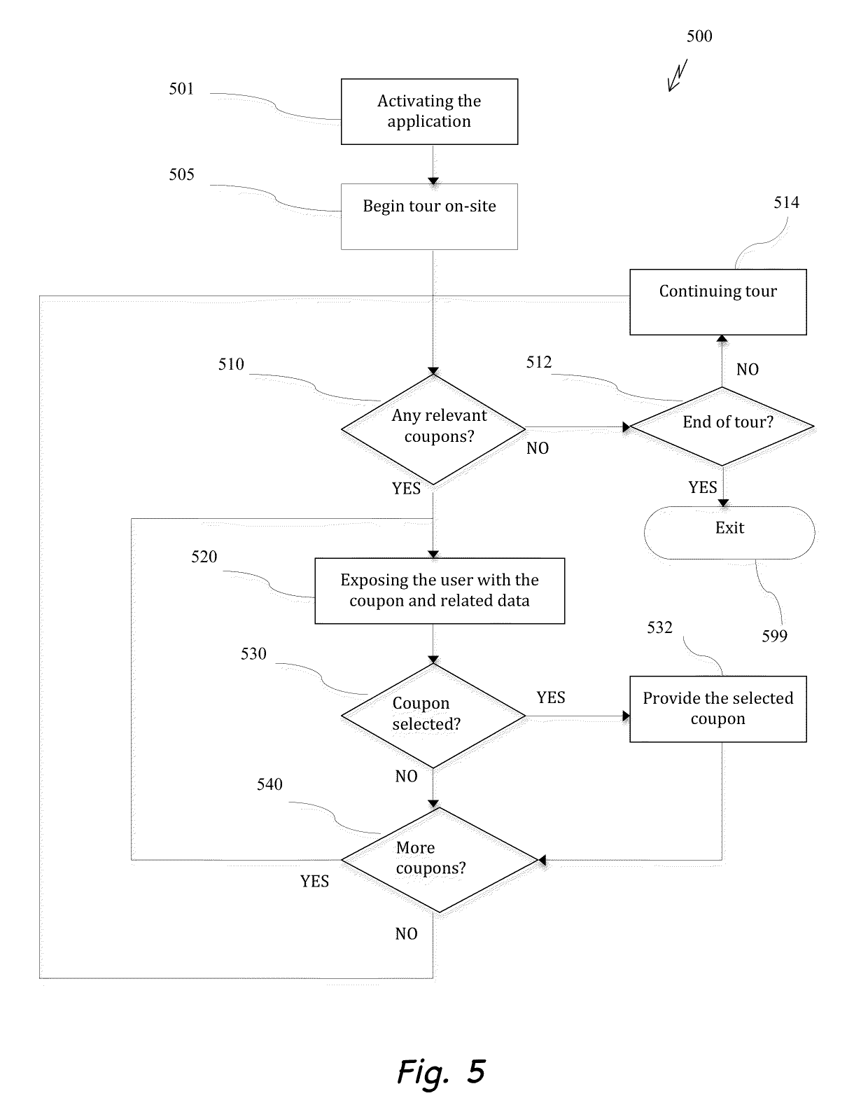

Reference is now made to FIG. 5, an example method 500 of a user 20, using a purchased guided tour on-site, according to embodiments of the present invention. When, or before arriving at the guided tour destination, user 20 activates user interface platform 150 (step 501). When, or before arriving on-site, activates user interface platform 150, and user interface platform 150, using GPS 41, identifies that an appropriate POI, as part of guided tour is to be activated, and brings up that guided tour to thereby start an interactive tour-guidance of the site (step 505). If the guided tour session includes more than one POI, user interface platform 150, using GPS 41, identifies each POI, and brings up the appropriate guided tour for each POI.

While the guided-tour session is on, process 500 proceeds as follows:

Step 510: check for relevant coupons. If a relevant coupon for the current tour location exists. Go to step 520.

Step 512: check is end of tour. If end of tour, go to exit (599).

Step 514: continue tour. Interactive tour guidance continues. Optionally, assuming a network 50 is available, during and/or after a guided tour, user 20 wishes will be offered to share his/her tour experience, using interactive-tour-guidance system 100, with friends of his/her choice. Go to step 510.

Step 520: exposing the user with the coupon and related data.

If a relevant coupon for the current tour location exists, user 20 is exposed with the coupon and related data

Step 530: check whether coupon is selected. If user does not select the offered coupon, go to step 540.

Step 532: provide the selected coupon. User 20 is provided with the selected coupon.

Step 540: check if more coupons exist or if the user privacy setting does not allow the offering of more coupons. If more coupons for the active guided tour exist, go to step 520. Else, go to step 510.

In some embodiments of the current invention, interactive-tour-guidance system 100 provides user 20 with a notice arriving, or just before arriving the starting point of a guided-tour.

In some embodiments of the current invention, interactive-tour-guidance system 100 provides user 20 with a route to return to the starting point of the guided-tour.

In some embodiments of the current invention, interactive-tour-guidance system 100 provides user 20 with a notice upon arriving, or just before arriving the location of a coupon provider.

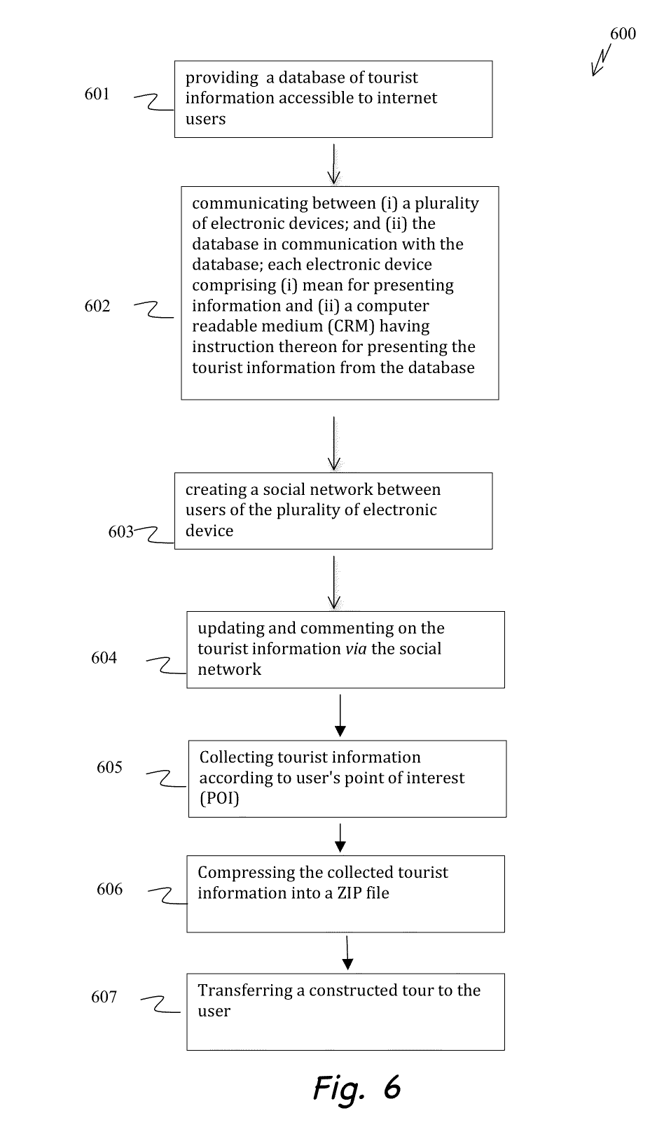

Reference is now made to FIG. 6 illustrating a method 600 for providing tourist and marketing information, comprising:
a. step 601 providing a database of tourist information accessible to internet users;
b. step 602 communicating between (i) a plurality of electronic devices, and (ii) the database in communication with the database, each electronic device comprising (i) means for presenting information and (ii) a computer readable medium (CRM) having instructions thereon for presenting the tourist information from the database.
c. step 603 creating a social network between users of the plurality of electronic device; and
d. step 604 updating and commenting on the tourist information via the social network.
e. step 605 collecting tourist information according to POI;
f. step 606 compressing and 607 transferring the database of the POI to the user.

In some embodiments of the current invention, plurality of mobile devices is provided with a designated tour-guide user interface platform. The user interface platform also functions as a social network. Each of the mobile devices is in communication with a data base of tour-guides. The social network is for among other things for commenting and reviewing the tour-guides. It may also serve as a platform for the users of the social network to provide tour-guides of their own.

In some embodiments of the current invention, information is displayed in a variety of languages. The user may choose, using the user interface platform settings the language in which any of the information delivered to him may be presented. The guided tours may change language, also the user interface platform interface and in some embodiments the marketing information.

In some embodiments of the current invention the tour-guides are to be used using a transit selected from a group consisting of: bicycle, motorcycle, airplane, car, walk, train, bus, rickshaw, skates, roller-blades, and a combination thereof.

In some embodiments of the current invention the instruction are additionally for optimizing the tour-guides according to parameters selected from a group consisting of: rating, length of route, unique of sited along routes, time of day in which tour-guide is taken, time of year in which tour-guide is taken, events along the tour and a combination thereof.

In some embodiments of the current invention the CRM is in communication with augmented reality application.

In some embodiments of the current invention the server comprises means for reducing file size of the database of tourist information. The means for reducing file size of the database of tourist information may comprise at least one compression utilities for compressing data files. Some traditional compression schemes and methods include ZIP, RAR, bzip2, Izma, among many others. Each compression utility uses one or more techniques, or methods, for compressing a file. While there are many utilities in existence that can create archive files that contain compressed data (files), the archive utilities may employ only a limited set of compression methods and further to provide an optimal compression for each file in a set of tiles to be archived. The means for reducing file size is selected from the group consisting of a zip file platform, RAR, bzip2, Izma, gzip, cutting file means, lossless data compression, PNG, GIF, TIFF, MNG and a combination thereof.

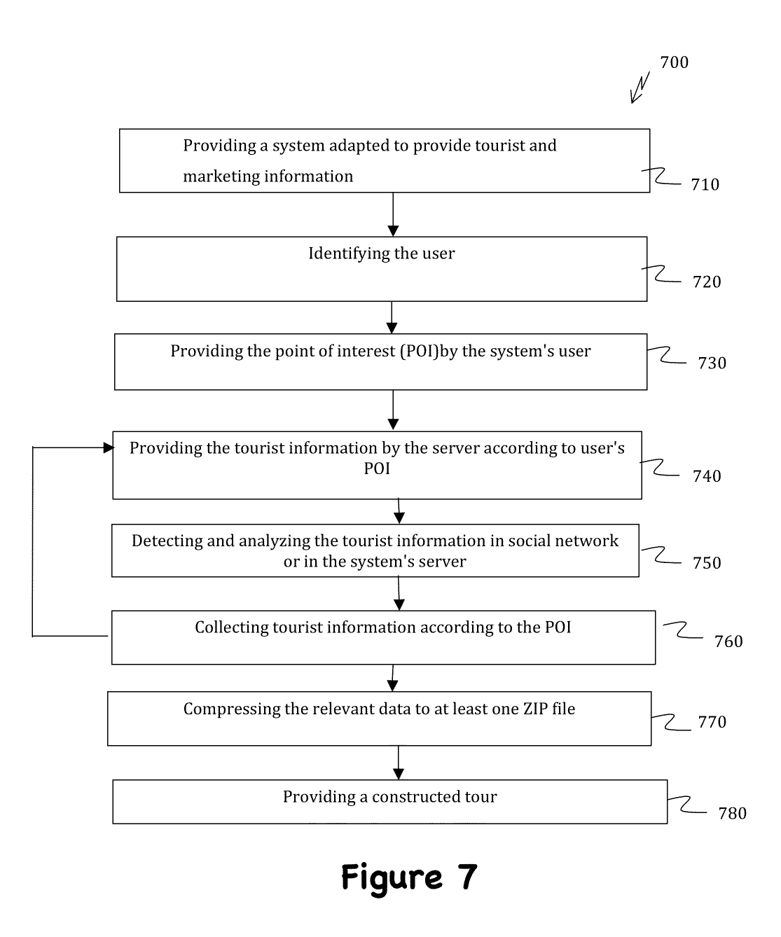

Reference is now made to FIG. 7 which illustrated a scheme for creating and delivering a tour according to a user's predefined user POI 700. The method comprising steps of providing a system adapted to provide tourist and marketing information 710, comprising a database of tourist information; the data base is accessible to internet users, a server for collecting and storing the database of tourist information, the server comprising means for reducing file size of the database of tourist information; and a plurality of electronic devices in communication with the database; each the electronic device comprising (i) means for presenting the tourist information according to predefined point of interest (POI) and, (ii) a computer readable medium (CRM) having instructions thereon for presenting the tourist information from the database; The user logs into the system, after identifying the user 720, the user defines his POI 730. The user may further log into at least one electronics device such as a smart phone or web application (user interface platform) and further requests a guiding tour according to the POI 740.

The server of the system detects and fetches data from different social networks accordingly. The server may further crawl a social network 750. The server may further retrieve the most relevant places, locations and data following the user POI.

The dynamic tour may be created from a combination of POI's. The system stores the collected data which are further relevant to the user and encapsulates a tour accordingly 760. The server may collect information in a format such as written data, texts, pictures, maps, images, within the database.

The server analyzes the relevant data and compressed the relevant data to at least one ZIP file to construct a tour for the user 770. The data is further compressed using means for reducing file size selected from the group consisting of a zip file platform, RAR, bzip2, Izma, gzip, PNG, GIF, TIFF, MNG. The data compressing is performed by selecting and cutting only the relevant data to the POI such as images, maps text data, video, pictures, photos, voice records, music and further eliminating unnecessary information for reducing the size of collected data.

The constructed tour is than transferred to the user 780.

The server may further repeats the steps of detecting, analyzing and collecting data according to the predefined POI in order to be updated with the recent data in the networks.

The user interface platform connects the server with the user ID and retrieve the most relevant places.

The suggested POI's may further be chosen based upon what the user's friends comment and like the most. The server may further combine several POIs which are stored in the system or collected from social networks to construct a tour following the user's POI.

The system than suggests and provides the user several potential and popular options for a tour following user's predefined POI.

The server may further provides advertisers relevant to the point of interest search such as restaurants, shopping centers and designers, hotels, hostels, culture events and places, pubs, clubs, and combination thereof.

### Example 1

In one example of the current invention, a tourist is walking by a monument; his mobile device detects the person location by using the mobile integrated GPS. Once the location is detected an audio is being automatically played by the mobile regarding the history of the monument.

### Example 2

In another example of the current invention, a database of video clips is stored on a cloud. The video clips are accessible through a special website, where users can comment and uploads more files. A mobile device user, which installed a designated user interface platform, may have access to these files and he can see past versions and comments of users which used the website to access the files.

### Example 3

In yet another example of the current invention, a tourist is travelling abroad, where he uses an online map in his mobile to navigate. On this map, the locations of various tourist attraction is presented, and of special shops. Each time the tourist is passing by a special shop a coupon may pop-up on his mobile device display. In addition, a video clip, describing special aspects of tourist attraction will pop up on the user's screen while he is standing in front of a tourist attraction.

### Example 4

In still another example of the current invention, a user of a mobile device is touring around the country; he is connected to a data base of files with information on his tour. These files are rated and he has access to past editions. Using a social network of the designated tourist information user interface platform, he may consult with other users, in specific content in the database.

### Example 5

It is an example of the current invention, wherein a tour guide is displayed upon a mobile device display. As the user is progressing according to the tour guide route, audio of historical landmarks is played, coupons of lunch pop-up on the display, and an option to call a taxi at the end of the tour is enabled.

### Example 6

In an example of the current invention, plurality of tour guides regarding the same location and sites are stored in a data base. A user interacts with the database, in order to select a tour, since the user is planning a trip during a cold season, the system will provide him with a tour which does not require staying outside for long periods of time.

### Example 7

In an example of the current invention, a tourist is located in a point of interest and is interacting with a user interface platform. The user interface platform then provides with touring options depending on whether he wants to walk or to bike. In case the he rents a bike from the city bike-service and returns it in the end of the tour at a different location, the user interface platform will provide him with a taxi service advertise to return him to his hotel.

It will be appreciated by persons skilled in the art that embodiment of the invention are not limited by what has been particularly shown and described hereinabove. Rather the scope of at least one embodiment of the invention is defined by the claims below.

1. A system adapted to provide tourist and marketing information, comprising:
a. a database of tourist information; said data base is accessible to internet users;
b. a server for collecting and storing said database of tourist information;
c. a plurality of electronic devices in communication with said database; each said electronic device comprising (i) means for presenting said tourist information and (ii) a computer readable medium (CRM) having instructions thereon for presenting said tourist information from said database;
wherein said database is updated by said internet users; further wherein said instructions are for (i) creating a social network between users of said plurality of electronic device according to predefined point of interest (POI); and (ii) updating and commenting on said tourist information via said social network; further wherein said server comprising means for reducing file size of said database of tourist information; said server focuses upon said POI such that said database of said POI is collected, compressed and transferred to said user.

2. The system according to claim 1, wherein said means for reducing file size is selected from the group consisting of a zip file platform, RAR, bzip2, Izma, gzip, PNG, GIF, TIFF, MNG.

3. The system according to claim 1, wherein said server further comprising a tour-guides management unit, a user's-management unit, an advertisers-management unit, a user identification platform and a database (DB) unit.

4. The system according to claim 1, wherein said means for presenting said tourist information is selected from a group consisting of screen, speaker, touch stimulator, any module adapted to stimulate a sense, and a combination thereof; further wherein said means for presenting said tourist information comprises an audio information regarding said POI.

5. The system according to claim 1, wherein at least one of said plurality of said electronic devices comprises a global positioning system (GPS).

6. The system according to claim 5, wherein said tourist information regarding said POI is presented upon detection of said electronic device in proximity of a specific location by said GPS.

7. The system according to claim 5, wherein said marketing information regarding a location is sent to said electronic device; said information is sent upon detection by said GPS of said electronic device in proximity to said location.

8. The system according to claim 1, wherein at least one of the following is true:
a. said information is presented automatically;
b. said information is presented upon request from said electronic device user;
c. said tourist information is a guided tour through several locations; and
d. said tourist information is presented in more than one language.

9. The system according to claim 1, wherein said update of data base is approved by at least one administrator.

10. The system according to claim 1, wherein marketing information is sent to said electronic device by an advertiser which is in communication with said database.

11. The system according to claim 1, wherein said server is configured to perform at least one of the following actions in said database: upload data, update existing data, receive business intelligent, and any combination thereof.

12. The system according to claim 1, wherein said server is further configured as a platform for said users of said social network to provide tour-guides; said tour-guides are used via a transit selected from a group consisting of: bicycle, motorcycle, airplane, car, walk, train, bus, rickshaw, skates, roller-blades, and a combination thereof.

13. The system according to claim 1, wherein said instructions are additionally for optimizing tour-guides according to parameters selected from a group consisting of: rating, length of route, unique of sited along routes, time of day in which said tour-guides are taken, time of year in which said tour-guides are taken, events along said tour and a combination thereof.

14. The system according to claim 1, wherein said CRM is in communication with augmented reality application.

15. A method for providing tourist and marketing information, comprising steps of:
a. providing a system adapted to provide tourist and marketing information, comprising:
i. a database of tourist information; said data base is accessible to internet users;
ii. a server for collecting and storing said database of tourist information, said server comprising means for reducing file size of said database of tourist information; and
iii. a plurality of electronic devices in communication with said database; each said electronic device comprising (i) means for presenting said tourist information according to predefined point of interest (POI) and, (ii) a computer readable medium (CRM) having instructions thereon for presenting said tourist information from said database;
b. communicating between (i) said plurality of electronic devices; and (ii) said database in communication with said database;
wherein said method additionally comprising steps of:
c. creating a social network between users of said plurality of electronic device;
d. updating and commenting on said tourist information via said social network;
e. focusing upon said POI; and
f. collecting, compressing and transferring said database of said POI to said user.

16. The method according to claim 15, wherein said means for presenting said tourist information is selected from a group consisting of screen, speaker, touch stimulator, any module adapted to stimulate a sense, and a combination thereof.

17. The method according to claim 15, wherein at least one of the following steps is true:
a. providing at least one of said plurality of electronic devices a global positioning system (GPS); and
b. presenting said tourist information regarding a specific location, upon detection of said electronic device in proximity of said specific location by said GPS

18. The method according to claim 15, additionally comprising step of sending said marketing information regarding a location to said electronic device; said information is sent upon detection by said GPS of said electronic device in proximity to said location.

19. The method according to claim 15, wherein at least one of the following steps is true:
a. presenting said information automatically;
b. presenting said information upon request from said electronic device use;
c. presenting said information as tour-guides through several locations; and
d. presenting said tourist information in more than one language.

20. The method according to claim 15, wherein said method additionally comprising step of approving said update of data base by at least one administrator.

21. The method according to claim 15, wherein said method additionally comprising step of sending marketing information to an electronic device by an advertiser.

22. The method according to claim 15, wherein said method additionally comprising step of communicating between advertiser and said database; said server is configured to perform at least one of the following actions in said database: uploading data, updating existing data, receiving business intelligent, and any combination thereof.

23. The method according to claim 15, wherein said method additionally comprising step of providing said means for presenting information with audio information regarding said POI.

24. The method according to claim 15, wherein at least one of the following steps is true:
a. using tour-guides with a transit selected from a group consisting of: bicycle, motorcycle, airplane, car, walk, train, bus, rickshaw, skates, roller-blades, and a combination thereof; and
b. optimizing said tour-guides according to parameters selected from a group consisting of: rating, length of route, unique of sited along routes, time of day in which said tour-guides are taken, time of year in which said tour-guides are taken, events along said tour and a combination thereof.

25. The method according to claim 15, additionally comprising step of communicating said CRM with an augmented reality application.
